(19) United States
(12) Patent Application Publication
(10) Pub. No.: US 2010/0230351 A1
(43) Pub. Date: Sep. 16, 2010

(54) Hydrophilic Membrane

(75) Inventors: Hendrik Derk Hoving, Susteren (NL); Jun Qiu, Heerlen (NL); Jens Christoph Thies, Eijsden (NL); Gijsbertus Hendrikus Maria Calis, Hulsberg (NL); Johannes Leonardus Maria Op Den Kamp, Beek (NL)

Correspondence Address: CONLEY ROSE, P.C., 5601 GRANITE PARKWAY, SUITE 750, PLANO, TX, 75024, US

(73) Assignee: LYDALL SOLUTECH, B.V., Heerlen (NL)

(21) Appl. No.: 12/670,113

(22) PCT Filed: Jul. 24, 2008
(86) PCT No.: PCT/EP08/59724

§ 371 Date: May 27, 2010

(30) Foreign Application Priority Data
Jul. 25, 2007 (EP) 07014585.9

(51) Int. Cl. B01D 67/00; B01D 61/00; B01D 61/36; B01D 61/42; B01D 61/02; B01D 61/14; B01D 71/70; B01D 71/52; B01D 71/02; B05D 3/06

(52) U.S. Cl. 210/650; 210/490; 427/532

(57) ABSTRACT

The invention relates to an hydrophilic membrane comprising a membrane carrier and a hydrophilic coating with good properties. The coating may comprise covalently bound inorganic-organic hybrid material; or the coating may comprise ring-opening polymerized components like epoxy resins. The coating composition preferably is applied in a solvent, the solvent is evaporated, and the coating is cured with UV radiation. The hydrophilic membrane is very useful in water purification, and in other applications.

The invention relates to a hydrophilic membrane, and to methods for making and to use of such membrane.

Membranes are commonly used for separation and concentration of solutions and suspensions. They have a broad application range and can be used in several molecular separations like micro filtration, ultra filtration, nano filtration, reverse osmosis, electro-dialysis, electro-deionization, pertraction, pervaporation. Examples of applications include waste water purification, fuel cells, controlled release of pharmaceutical compononents, batteries and humidifiers.

Most of the membranes are made from hydrophobic materials like polyethylene (PE), polypropylene (PP), poly(vinylidene-difluoride) (PVDF), polytetrafluoroethylene (PTFE). These membranes are not suitable by themselves for water filtration as it requires a relatively high pressure gradient to get water through the membrane because of high capillary force in hydrophobic membrane pores. In addition, the hydrophobic surface is prone to fouling, compared to a hydrophilic one. Some membranes are hydrophilic, such as cellulose-acetate and nylon based materials. The cellulose-acetate ester membranes, however, are prone to degradation by enzymes, and nylon has inherent disadvantages as it is difficult to make highly porous membranes, hence the flux is limited. In contrast, many of the hydrophobic polymers are inherently stable. Hence, for a long time methods have been developed, to make hydrophobic membranes more hydrophilic, thus maintaining stability and improved flux.

A number of methods are currently used to make hydrophobic membranes hydrophilic. In one of these, plasma treatment (i.e., gas plasma treatment) is used to modify the surface of the membrane. Plasma treatment generally is not able to modify the inside of membranes. In another method, a coating is applied or grafted on the surface, based on hydrophilic acrylate monomers. A solution of mono- and/or multifunctional acrylates in an alcohol or water is polymerised by applying heat, while using a redox-radical initiator, see e.g. U.S. Pat. No. 4,618,533 or U.S. Pat. No. 7,067,058. These current methods have disadvantages. In case water is used as a solvent, the wetting capability is still limited; and it can be difficult to wet also small pores. In case alcohol is used as a solvent, wetting may be less of a problem, but the thermosetting polymerisation at higher temperature may cause the hydrophobic matrix shrinkage, resulting in pore blockage. Furthermore, polymer blends are used, in which hydrophilic and hydrophobic polymers are mixed and processed into membranes. However, the intrinsic porosity, structure of hydrophobic membrane has been completely altered, additionally, the natural incompatibility of polymer blending might lead to a phase separation, and it is hard to get desirable transport performance.

It is noted that WO2006/016800 discloses a coating obtainable from a coating composition comprising particles being grafted with reactive groups and hydrophilic polymer chains. Although the coating shows several advantages, application of the coating on a membrane is not disclosed. Also, inorganic materials such as silicon oxide nano particles are disclosed, but no oligomer is disclosed.

Further, membranes with some hydrophilic character need further improvement.

Hence, both the hydrophilicity of membranes, as well as the process still awaits further improvement.

The present invention is able to provide membranes with a higher flux than obtained with previous methods or modifications.

In a first embodiment of the present invention, the hydrophilic membrane comprises a membrane carrier and a hydrophilic coating, the coating comprising a covalently bound inorganic-organic hybrid material. The coating is prepared from a hydrophilic coating composition comprising an inorganic-organic hybrid material with reactive groups, the inorganic part being a metaloxide oligomer.

It appeared that a coating comprising an inorganic-organic material covalently bound in the coating exhibits better hydrophilic properties than a coating not comprising such hybrid material. It was unexpected, that the coating comprising such hybrid material also is more stable against washing with either methanol or water.

A coating is defined in this invention as a (semi)continuous layer on the membrane carrier. This is contrasted to individual particles that may be attached to a membrane. With Scanning Electron Microscopy (SEM), it is easily discernable that a coating is formed.

It is to be noted that the coating on the membrane carrier is impregnated in the membrane carrier, i.e. the coating is present on the significant portion of the inner surfaces of the pores of the membrane carrier to allow water to penetrate through the membrane. The coating is preferably also present on the outer (macroscopic) surface of the membrane.

In this first embodiment, the membrane carrier is coated with a hydrophilic coating composition comprising an inorganic-organic hybrid material with reactive groups. Unless otherwise stated, the inorganic-organic hybrid material referred hereinbelow denotes the inorganic-organic hybrid material in the hydrophilic coating composition, which is to be cured to form a part of the hydrophilic coating.

The inorganic-organic material generally has an inorganic part, generally being a metal-oxide oligomer. Preferably, the metal ion is a mono-,or di-,or tri or tetra-functional oxide and forms a highly functional network. Such material is also denoted herein below as colloidal metaloxide.

The inorganic-organic material has groups that are able to react in an organic curing mechanism, which groups are denoted in this invention as reactive groups. An organic curing mechanism means that organic reaction(s) cause a polymerisation to occur. Many different curing reactions can be used, as will be exemplified below.

The metaloxide suitable in the inorganic-organic material may comprise siliciumoxide, titanium oxide, magnesiumoxide, stannumoxide, aluminiumoxide, zirconiumoxide, zincoxide, ceriumoxide and/or mixtures thereof. Apart from metal-oxides, it is possible to use metal-sulphides or other molecules as will be apparent for the skilled man.

In a preferred embodiment of the present invention, the metal is silicium, titanium, aluminum, zinc or zirconium, most preferably silicium.

The colloidal metaloxide may be prepared from hydroxy and/or alkoxy metal-compounds. Alkoxy compounds are preferred, such as for example tetra-ethoxy silane, tetra-ethoxy zirconate and -methoxy titanate.

The organic groups of the inorganic-organic material in the coating preferably are formed in-situ, but may be added afterwards. Preferably, organic silanes or organic titanium compounds are used, like for example organic functional-trimethoxy silanes. Suitable examples of functional silanes are acryloyl functional silanes, epoxy functional silanes, mercapto-functional silanes and the like, wherein the silyl compound comprises hydrolysable groups.

Preferably, the organic silane is able to form a silanol group by hydrolysis. The silane compound preferably comprises an alkoxy group, aryloxy group, acetoxy group, amino group, a halogen atom, or the like, bonded to a silicon atom. An alkoxy group or aryloxy group is preferred. As the alkoxy group, alkoxy groups containing 1-8 carbon atoms are preferable; and as the aryloxy group, aryloxy groups containing 6-18 carbon atoms are preferable. Methoxy, or ethoxy is preferred.

The silanol group or the silanol group-forming group is a structural unit which may bond to the colloidal metaloxide by condensation or condensation following hydrolysis.

In a preferred embodiment of the present invention, the colloidal metaloxide with reactive groups is made by reacting tetra-alkoxy metal compound (A) and tri-alkoxy-organic metal compound (B) in a solvent. The molar amount of these components may vary. Preferably the amount of the tetra-alkoxy metal (A) is about the same molar ratio as organic-metal compound (B) or a higher ratio. More preferably, the molar ratio (A):(B) is about 2 or higher. Generally, the ratio (A):(B) will be about 20 or lower, preferably about 15 or lower.

In a preferred embodiment of the present invention, the inorganic-organic material is a metaloxide oligomer with reactive groups. Such oligomer is sufficiently small, that virtually all pores of any membrane are accessible for the coating, and virtually no pores will be blocked. One example of an oligomer is the oligomerised TEOS, another is polyhedral oligomeric silsesquioxane, and others will be apparent to the skilled man.

The molecular weight (Mw) as measured with GPC preferably is about 50,000 dalton or lower, more preferably about 20,000 dalton or lower, and most preferred about 10,000 or lower. Generally, the molecular weight as apparent from GPC will be about 500 dalton or higher, preferably about 1000 or higher. The molecular weight with GPC may be determined with a Waters Styragel column HR2 in THF, with THF as elution solvent; e.g. 80 μl injection volume on a 7.8×300 mm size column.

Preferably, the oligomer has a polydispersity of about 1.8 or higher, more preferably about 2.1 or higher. The higher polydispersity allows a broad range of pores to be well wetted with the colloidal metaloxid. Generally, the polydispersity as measured with GPC will be about 5 or lower.

Preferably, the size of the oligomer as measured with dynamic light scattering is about 0.5 nm or higher, preferably about 1 nm or higher. Preferably, the apparent size as measured with light scattering is about 10 nm or lower, preferably about 5 nm or lower.

The inorganic-organic material has groups that are able to react in an organic curing mechanism. The reactive groups may be alcohol (C—O—H), amine, mercapto, isocyanate, acrylate, vinyl, epoxy, and/or carboxylic acid, mixtures thereof and/or reactive derivatives thereof. Which reactive group is able to react in an organic curing mechanism, depends on the type of mechanism chosen. For example: mercapto or amine may be reactive with isocyanates or vinyl-unsaturation; acrylates are reactive in radical polymerisation; epoxy, alcohol, and oxetane are reactive in cationic curable systems; vinyl is reactive in radical and in certain cationic curable systems; and isocyanate, amine, epoxy and hydroxy are reactive in isocyanate or epoxy addition reaction.

The inorganic-organic hybrid material with reactive groups may be the only reactive component in the coating composition (besides a reaction initiator), in which case the reactive groups preferably can homo-polymerise. Suitable examples of such groups include epoxy and acrylate.

In a preferred embodiment, the coating composition further contains components that can polymerize with the reactive groups on the surface of the particles. Examples of suitable components are mono-functional reactive diluents and poly-functional crosslinking compounds for which examples will be given below.

Generally, the amount of inorganic-organic hybrid material will be about 2 wt % or more of the solid material of the coating composition. The solid material is the composition after evaporation of the (non-reactive) solvent. Preferably, the amount of hybrid material will be about 5 wt % or more. Generally, as explained above, substantially all of the coating may be the hybrid material, but about 50 w % or less will be more than adequate for getting good properties and is therefore preferred, and about 30 wt % or less can be suitable as well. It may be an advantage to have about 30 wt % or less of the hybrid material in order to allow a sufficient low cross-link density to keep large pore sizes.

In another embodiment of the invention the hydrophilic membrane comprises a membrane carrier and a hydrophilic coating, the hydrophilic coating is obtained by polymerisation reactions comprising ring-opening polymerisation.

Preferably, about 30% or more of the polymerisation is a ring-opening polymerisation, preferably about 50% or more, and even more preferably about 80% or more.

Unexpectedly, the coatings obtained with ring-opening polymerisation have better wetting properties than for example radically polymerised polymers.

Preferably, the coating composition exhibits upon cure a shrinkage of 8 vol % or less, preferably about 6% or less, and most preferred about 4 vol % or less. Acrylate systems and other radically polymerisable systems generally cause 10-15 vol % of shrinkage upon cure. Volume shrinkage is measured by curing with free shrinkage over all dimensions. The inventors postulate that less shrinkage of the coating allows for better adhesion to the carrier membrane. Thereby, the properties of the hydrophilic membrane are improved.

Suitable examples of ring-opening polymerisation are epoxy, oxazoline, oxetane and caprolactone polymerisation. In the calculation of the percentage, the reaction of (for example) an (activated) epoxy with an alcohol-group also is part of the ring-opening polymerisation.

In this embodiment, the term ring-opening polymerisation comprises isocyanate addition reactions, as these—like ring-opening—do cause limited shrinkage, and cause heterogeneous atoms to be present in the polymer backbone that is formed upon cure on the membrane carrier.

In a preferred embodiment, the coating composition comprises blocked isocyanates, curable with polyetheramines or polyetheralocohols, and the like.

In yet another embodiment, the coating composition comprises components suitable for ring-opening polymerisation such as oxazoline functional components and the like, which are also cationic curable

In yet another embodiment, the coating composition comprises components suitable for ring-opening polymerisation such as aziridine functional components and the like, which are also anionic curable

In a preferred embodiment, the coating composition contains one or more epoxy functional compounds.

The cured coatings obtained from compositions comprising epoxy-functional groups exhibit better wetting properties of the coated membrane than acrylate based systems.

Epoxy based coating compositions are known as such, and may comprise aliphatic or aromatic epoxy compounds as exemplified below. The epoxy based coating composition further may comprise mono- and/or polyols. Preferred examples of poly-alcohol components are polyethylene glycol of several molecular weights, polyethylene glycol-mono-methyl ether and the like. The epoxy based coating composition may be heat curable, but is preferably UV curable.

The coating composition containing one or more compounds with ring-opening functional groups such as for example an epoxy resin, may further comprise other polymerisable systems as to obtain hybrid (dual cure) polymerised systems, like for example acrylate/epoxy or epoxy/isocyanate, acrylate/isocyanate. The dual cure systems may comprise compounds that are able to react in both curing mechanisms, to obtain further crosslinked coatings. For example, glycidyl-methacrylate can be used as a monomer in an epoxy/acrylate dual cure system.

In order to achieve homogenous wetting by the coating formulation throughout the membrane carrier pores, the viscosity of the coating composition preferably is about 0.1 Pa·s or lower, preferably about 0.01 Pa·s or lower, and most preferably about 5×10⁻³ Pa·s or lower. In order to achieve such low viscosity, it is preferred to use a solvent as a thinner. Useful solvents are exemplified below. The word solvent is denoted here as a compound that is substantially non-reactive with the components of the coating composition. In contrast, reactive diluents which are also used to lower the viscosity of a coating composition generally comprise a group which is able to polymerize with the other components of the coating composition. Solvents generally can be evaporated.

The coating composition may further comprise other components such as for example hydrophilic homopolymer or copolymers as to obtain hybrid systems, (single cure, interpenetrating network) like for example acrylate/polyvinyl alcohol, epoxy/polyvinyl alcohol, acrylate/polyvinyl pyrrolidone, epoxy/polyvinyl pyrrolidone, acrylate/ethylene-co-vinyl alcohol, epoxy/ethylene-co-vinyl alcohol, acrylate/polyethylene glycol, epoxy/polyethylene glycol.

The coating composition may further comprise additives, like nano-size active carbon, enzymes, pharmaceuticals, nutraceuticals, ion exchange resin and the like.

The membrane carrier can be any known membrane, and newly developed membrane. Suitable membranes can be a membrane carrier made from inorganic (metal, zeolite, alumina) or organic material. The organic membranes preferably are made from polyethylene, polypropylene, polyethersulphone, polysulphone, polyvinylidenefluoride, polytetrafluoroethylene, polycarbonate, mixed polymers membranes, and can comprise plasma treated membranes and the like.

In one embodiment of the invention, the membrane is based on polyethylene, preferably ultra-high molecular weight polyethylene, in particular highly stretched UHMWPE. A membrane based on UHMWPE has as advantage that it is highly dimensional stable, also under stress, and that thin micro-porous membranes with high porosity can be made. Particularly, it was found that a high content of ultra high molecular weight polyethylene (UHMWPE) is advantageous as UHMWPE may be processed by extrusion and afterwards being stretched to form a very strong and affordable membrane as well as a membrane that is both chemically and mechanically stable (e.g. with regard to thermal cycling and swelling behaviour). Examples of useful membranes include those with polyalkenes comprising about 20 weight-% UHMWPE or more. Preferably, the membrane carrier comprises about 40 weight-% UHMWPE or more. If high temperature resistant membranes are required, it may be advantageous to use membranes with about 70 weight % UHMWPE or more. Suitable grades exist with for example about 25 wt %, about 50 wt %, about 75 wt %, about 90 wt % and about 100 wt %, the remainder of the material preferably being another polyolefin, such as HDPE, LLDPE, LDPE, PP and the like. Preferably, mixtures of HDPE and UHMWPE are used. A preferred polyolefin based membrane carrier comprises 40-60 wt % of UHMWPE and 60-40 wt % HDPE.

In a preferred embodiment of the invention, the membrane carrier is a hydrophobic membrane comprising UHMWPE useful as self-supporting membrane. A hydrophilic membrane based on a carrier membrane comprising UHMWPE has as additional advantage that the membrane exhibits high strength and high porosity.

In a particularly advantageous embodiment the UHMWPE part of the polyalkene consists substantially of UHMWPE with a weight average molecular weight of about 500,000-10,000,000 g/mol. The lower limit corresponds to the required (lower) tensile strength of the membrane whereas the upper limit corresponds to an approximate limit where the material becomes too rigid to process easily. The UHMWPE may be bi-modular or a multimodular mixture, as that increases processability.

Typically, a biaxially stretched ultra high molecular weight polyethylene film forming a membrane according to the invention provides a tensile strength in the machine direction of about 7 MPa or higher, preferably about 10 MPa or higher. In case a very high strength is required, the membrane can have a tensile strength of about 40 MPa or higher. The high strength allows for much thinner membranes and/or membranes that do not require supporting rigid grids during use. Furthermore, the elongation at break for such polyethylene membranes is typically in the order of 30% in the machine direction. This allows for a substantial (elastic) deformation during use without deteriorating the performance of the membrane.

A preferred membrane has a thickness of about 0.5 mm or less, preferably about 0.2 mm or less. A thinner membrane has the advantage of potentially higher water flux.

In one embodiment of the invention (regarding self-bearing membranes), the thickness of the membrane will be about 10 μm or more, preferably about 20 μm or more, to achieve a higher strength. The thickness generally will be about 500 μm or less, preferably about 200 μm or less. Suitable membranes for example may have a thickness of about 50, about 100 or about 120 μm. Although the membrane may be ‘self-bearing’, several types of such membranes are used on a carrier to improve strength. Self bearing means in this specification, that the membrane can be made without a further carrier, i.e., the membrane formed of a membrane carrier and a coating does not need to be provided with a further carrier.

In another embodiment of the invention, the coating comprises a thin layer on the membrane carrier, and the layer may be about 20 nm or more, preferably about 80 nm or more. Often, such layers have a thickness of about 5 μm or less, preferably 1 μm or less. The coating is thus present on the outer surface of the membrane carrier as a layer, as well as in the pores of the carrier. Generally, these membranes are made by phase inversion. Alternatively, these membranes are made by hot or cold stretching processes. Suitable examples include membrane polyethersulfone, polyphenylsulfone, polyacrylonitrile, polyvinyldifluoride, polyetherimide, and polysulphones

In another embodiment, the membrane carrier is PVDF or PTFE or PP or PES. These membranes can be in the form of a self-bearing membrane of thickness of about 50 μm or higher, and about 500 μm or lower with a pore size suitable for microflitration. With the present invention, it is easily possible to make hydrophilic membranes with carrier membranes of PVDF or PTFE or PES with a pore size suitable for micro and for nano-filtration.

The porosity of the hydrophobic membrane preferably is about 15% or higher (for example arc processed PC membranes), preferably about 40% or higher, and may be for example between 70 and 90%. Unexpectedly, the porosity is not necessarily greatly influenced by the hydrophilic coating. This is apparent from the limited thickness change (less than 5%), the limited amount of weight (1-3 g/m²), and SEM pictures, showing virtually no change in porosity structure.

As is shown in the examples, it appeared possible to adjust the pore size of the hydrophilic membrane by varying the crosslink density of the coating. It was unexpected, that for the hydrophilic membrane comprising a membrane carrier and a coating, it is possible to have a tuneable pore size from micrometer to nanometer with relatively high water flux under low pressure gradient. With for example epoxy based coating compositions, and a membrane carrier having a pore size of 0.4 μm, and, depending on the epoxy/hydroxy ratio of the coating composition, the pore size of the hydrophilic membrane varied between 0.06 to 0.18 μm.

The present invention also relates to a method of tuning the pore size of a membrane. The method of tuning a pore size for hydrophilic membranes comprises, using a membrane carrier with a certain pore size, and a coating with a cross-link density, wherein the cross-link density is varied to obtain different pore sizes, a higher cross-link density giving smaller pore size.

Preferably, the pore size is varied from micrometer to nanometer scale and the hydrophilic membrane shows relatively high water flux under low pressure gradient.

Preferably, the coating is an epoxy based coating composition.

In a preferred embodiment of the invention, the pore size of the membrane carrier is about 0.001 μm or higher, preferably 0.01 μm or higher. Generally, the pore size will be about 100 μm or lower, preferably about 10 μm or lower, preferably about 2 μm or lower, and more preferably 1 μm or lower.

The hydrophilic membrane will have a preferred pore size of about 0.5 nm or higher, allowing for reverse osmosis. In a preferred embodiment, the pore size is about 10 nm or higher, allowing for ultrafiltration. In another preferred embodiment, the pore size is about 100 nm or higher, as to allow for optimal microfiltration. The preferred pore size will be about 10 μm or lower as to achieve high water flux and particle filtration. In a particularly preferred embodiment—allowing good filtration in the micro and ultrafiltration range—the pore size will be about 1 μm or lower.

The pore size can be measured with directly with PMI —as shown in the examples—, and indirectly with air flow techniques.

The process to obtain a hydrophilic membrane comprises the steps of
(1) coating a membrane carrier with a coating composition, wherein the coating composition comprises hydrophilic components with reactive groups and an organic solvent
(2) optionally, evaporating the solvent
(3) curing the coating.

Generally, after the curing reaction has been completed, the membrane is washed. In this washing step, remaining non-reacted chemicals and non-crosslinked oligomers are being washed out from the membrane. Generally, after washing, the membrane is dried. The washing may of course also occur during actual use, and drying is not necessary as such. However, it is most common to wash and dry the membranes. In this specification, generally the characteristics of the hydrophilic membrane are given of washed and dried membranes, as described in the examples.

In a further embodiment of the present invention, the organic solvent comprises a non-polar solvent. Suitable non-polar solvents include but are not limited to aliphatic or aromatic solvents and ethers. Suitable examples include hydrocarbon cuts, toluene, methyl-tertiary-butyl-ether (MTBE) and dioxane. The use of non-polar solvents has the advantage of optimal wetting, and fast evaporation, prior or after cure. Preferably, the solvent comprises about 50 wt % non-polar solvent, and even more preferred about 80 wt % or more.

In another embodiment of the invention, the organic solvent further may be, or comprises, a polar solvent, which is non-protic. Suitable examples include esters and ketones, like butyl-acetate, ethyl-acetate, acetone, methyl-ethyl ketone (MEK), methyl-isobutyl ketone (MIBK) and the like. Using these non-protic polar solvents has as advantage that the components used for the hydrophilic coating are better soluble, yet the polymerisation reaction is not strongly influenced (which may be the case with protic solvents)

In another embodiment, the organic solvent comprises a protic solvent, which is preferably evaporated prior to cure. For example alcohol, isopropanol and butanol and the like can suitably be used. Water may be present in relatively small amounts, although it is not preferred.

In one embodiment of the invention, the organic solvent is evaporated, to about 80 wt % (based on the amount of organic solvent in the coating composition) or more, preferably about 90 wt % or more, and most preferred about 95 wt % or more. This has an advantage that a thin coating on the membrane fibrils or other surface members is formed, and that little coating material is filling the pores. Hence, an intimate contact is obtained between the reactive components of the coating composition and the fibrils of the membrane prior to curing.

In a preferred embodiment, the cure is effected by electro-magnetic irradiation, with for example UV light, (UV light in this application is including UV-VIS light), or electron beam.

Curing by UV-light initiation appeared also possible with membranes having an opaque appearance. It was unexpected that UV curing was even sufficient to obtain coated membranes that could withstand severe washing conditions. In a preferred embodiment of the invention, UV curing is applied to membranes of a thickness of about 10 μm or more, having an opaque appearance to the human eye.

In another embodiment, the cure is effected by heat, for example through IR radiation, or by applying heat.

In a preferred embodiment of the invention, the coating composition is applied in a roll-to-roll process. In such a semi-continuous process, the membrane carrier is unwinded from a roll, optionally pulled through a wetting unit, pulled through a coating application unit, passed through a drying and curing unit, and rewinded on a next roll.

Preferably, the curing is effected by UV or UV-VIS radiation, as that allows fast cure. It was unexpected, that non-transparent membranes with a thickness of over 100 μm coated with a UV-curable coating, could be well cured by UV light. The evaporation of the solvent can be done before or after cure. It is preferred, that the solvent is evaporated prior to cure to about 80% or more, and that curing is effected thereafter. Although UV light is preferred, roll-to-roll processes with thermal cure are known and can be used without problem, although they require longer time (and hence, either longer heating ovens, or slower linear speed), causing less optimal economics.

The coatings as applied in this invention may show a substantial percentage of extractables initially. However, as appears from the examples, the coated membrane after washing shows stable wetting and other properties.

In a preferred embodiment of the present invention, the membranes are coated, the coating is cured (optionally after evaporation of the solvent), and the membrane with cured coating is subjected to a washing step, after which the membrane is dried.

The amount of coating as measured after the washing and drying step on self-bearing membranes generally will be about 0.3 g/m² or more, preferably about 1 g/m² or more. Generally, the amount will be about 10 g/m² or less, preferably about 5 g/m² or less. A too low amount may result in less favourable wetting properties, a too high amount may cause reduced porosity.

Generally, the amount of coating after the washing and drying step will be about 3% of the membrane weight or more, preferably about 7% of the membrane weight or more. Generally, the amount will be about 50% of the membrane weight or less, preferably about 30% or less. The membrane weight is the weight of the active membrane carrier, disregarding any strength member for holding the membrane.

The components that can polymerize with the reactive groups of the colloidal metaloxide hybrid material may comprise one, two or more polymerizable groups in the molecule. Suitable polymerizable groups include for example epoxy, oxetane, hydroxy, amine, (blocked isocyanates, (meth)acrylates and vinyl. Of these, epoxy and (meth)acrylates are preferable.

Suitable examples of (meth)acrylate compounds are 2-hydroxyethyl(meth)acrylate, 2-hydroxypropyl(meth)acrylate, 2-hydroxybutyl(meth)acrylate, 2-hydroxy-3-phenyloxypropyl(meth)acrylate, 1,4-butanediol mono(meth)acrylate, 2-hydroxyalkyl(meth)acryloyl phosphate, 4-hydroxycyclohexyl(meth)acrylate, 1,6-hexanediol mono(meth)acrylate, neopentyl glycol mono(meth)acrylate, trimethylolpropane di(meth)acrylate, trimethylolethane di(meth)acrylate, pentaerythritol tri(meth)acrylate, dipentaerythritol penta(meth)acrylate, tris(2-hydroxyethyl)isocyanurate tri(meth)acrylate, ethylene glycol di(meth)acrylate, 1,3-butanediol di(meth)acrylate, 1,4-butanediol di(meth)acrylate, diethylene glycol di(meth)acrylate, triethylene glycol di(meth)acrylate, dipropylene glycol di(meth)acrylate, and bis(2-hydroxyethyl)isocyanurate di(meth)acrylate; poly(meth)acrylates prepared by adding ethylene oxide or propylene oxide to the hydroxyl group of these (meth)acrylates; and oligoester(meth)acrylates, oligoether(meth)acrylates, oligourethane(meth)acrylates, and oligoepoxy(meth)acrylates having two or more (meth)acryloyl groups in the molecule, N-vinyl pyrrolidone, N-vinyl caprolactam, vinyl imidazole, vinyl pyridine; acryloyl morpholine, (meth)acrylic acid, caprolactone acrylate, tetrahydrofurfuryl(meth)acrylate, butoxyethyl(meth)acrylate, ethoxydiethylene glycol(meth)acrylate, phenoxyethyl(meth)acrylate, polyethylene glycol mono(meth)acrylate, polypropylene glycol mono(meth)acrylate, methoxyethylene glycol(meth)acrylate, ethoxyethyl(meth)acrylate, methoxypolyethylene glycol(meth)acrylate, methoxypolypropylene glycol(meth)acrylate, diacetone(meth)acrylamide, beta-carboxyethyl(meth)acrylate, phthalic acid (meth)acrylate, isobutoxymethyl(meth)acrylamide, N,N-dimethyl(meth)acrylamide, t-octyl(meth)acrylamide, dimethylaminoethyl(meth)acrylate, diethylaminoethyl(meth)acrylate, butylcarbamylethyl(meth)acrylate, n-isopropyl(meth)acrylamide fluorinated (meth)acrylate, 7-amino-3,7-dimethyloctyl(meth)acrylate, N,N-diethyl(meth)acrylamide, N,N-dimethylaminopropyl(meth)acrylamide, hydroxybutyl vinyl ether, ethylene glycol vinyl ether, diethylene glycol divinyl ether, and triethylene glycol vinyl ether and compounds represented by the following formula (I) Formula I

CH₂═C(R⁶)—COO(R⁷O)ₘ—R⁸

wherein R⁶ is a hydrogen atom or a methyl group; R⁷ is an alkylene group containing 2 to 8, preferably 2 to 5 carbon atoms; and m is an integer from 0 to 12, and preferably from 1 to 8; R⁸ is a hydrogen atom or an alkyl group containing 1 to 12, preferably 1 to 9, carbon atoms; or, R⁸ is a tetrahydrofuran group-comprising alkyl group with 4-20 carbon atoms, optionally substituted with alkyl groups with 1-2 carbon atoms; or R⁸ is a dioxane group-comprising alkyl group with 4-20 carbon atoms, optionally substituted with methyl groups; or R⁸ is an aromatic group, optionally substituted with C₁-C₁₂ alkyl group, preferably a C₈-C₉ alkyl group, and alkoxylated aliphatic monofunctional monomers, such as ethoxylated isodecyl(meth)acrylate, ethoxylated lauryl(meth)acrylate, and the like.

Of these, (poly)ethyleneglycol based and hydroxy functional acrylates are preferable.

The polymerizable component preferably contains at least one epoxy-group containing component. The epoxide-containing components that are used in the compositions, according to this invention, are compounds that possess on average at least one 1,2-epoxide group in the molecule.

The epoxide-containing components, also referred to as epoxy materials, are cationically curable, by which is meant that polymerization and/or crosslinking and other reaction of the epoxy group is initiated by cations. The materials can be monomeric, oligomeric or polymeric and are sometimes referred to as “resins.” Such materials may have an aliphatic, aromatic, cycloaliphatic, arylaliphatic or heterocyclic structure; they comprise epoxide groups as separate groups, or those groups form part of an alicyclic or heterocyclic ring system. Epoxy resins of those types are generally known and are commercially available.

Examples of suitable epoxy materials include polyglycidyl and poly(methylglycidyl)esters of polycarboxylic acids, or poly(oxiranyl)ethers of polyethers. The polycarboxylic acid can be aliphatic, such as, for example, glutaric acid, adipic acid and the like; cycloaliphatic, such as, for example, tetrahydrophthalic acid; or aromatic, such as, for example, phthalic acid, isophthalic acid, trimellitic acid, or pyromellitic acid. The polyether can be poly(tetramethylene oxide). It is likewise possible to use carboxy terminated adducts, for example, of trimellitic acid and polyols, such as, for example, glycerol or 2,2-bis(4-hydroxycyclohexyl)propane.

Suitable epoxy materials also include polyglycidyl or poly(-methylglycidyl)ethers obtainable by the reaction of a compound having at least one free alcoholic hydroxy groups and/or phenolic hydroxy groups and a suitably substituted epichlorohydrin. The alcohols can be acyclic alcohols, such as, for example, ethylene glycol, diethylene glycol, and higher poly(oxyethylene)glycols; cycloaliphatic, such as, for example, 1,3- or 1,4-dihydroxycyclohexane, bis(4-hydroxycyclohexyl)methane, 2,2-bis(4-hydroxycyclohexyl)propane, or 1,1-bis(hydroxymethyl)cyclohex-3-ene; or contain aromatic nuclei, such as N,N-bis(2-hydroxyethyl)aniline or p,p′-bis(2-hydroxyethylamino)diphenylmethane.

The epoxy compounds may also be derived from mononuclear phenols, such as, for example, from resorcinol or hydroquinone, or they may be based on polynuclear phenols, such as, for example, bis(4-hydroxyphenyl)methane (bisphenol F), 2,2-bis(4-hydroxyphenyl)propane (bisphenol A), or on condensation products, obtained under acidic conditions, of phenols or cresols with formaldehyde, such as phenol novolacs and cresol novolacs.

Examples of suitable epoxy materials include poly(S-glycidyl) compounds which are di-S-glycidyl derivatives which are derived from dithiols, such as, for example, ethane-1,2-dithiol or bis(4-mercaptomethylphenyl)ether.

Other examples of suitable epoxy materials include bis(2,3-epoxycyclopentyl)ether, 2,3-epoxy cyclopentyl glycidyl ether, 1,2-bis(2,3-epoxycyclopentyloxy)ethane, bis(4-hydroxycyclohexyl)methane diglycidyl ether, 2,2-bis(4-hydroxycyclohexyl)propane diglycidyl ether, 3,4-epoxycyclohexylmethyl-3,4-epoxycyclohexanecarboxylate, 3,4-epoxy-6-methylcyclohexylmethyl-3,4-epoxy-6-methylcyclohexanecaboxylate, di(3,4-epoxycyclohexylmethyl)hexanedioate, di(3,4-epoxy-6-methylcyclohexylmethyl)hexanedioate, ethylenebis(3,4-epoxycyclohexanecarboxylate), ethanedioldi(3,4-epoxycyclohexylmethyl)ether, vinylcyclohexene dioxide, dicyclopentadiene diepoxide, -(oxiranylmethyl)-(oxiranylmethoxy)poly(oxy-1,4-butanediyl), diglycidyl ether of neopentyl glycol, or 2-(3,4-epoxycyclohexyl-5,5-spiro-3,4-epoxy)cyclohexane-1,3-dioxane, and combinations thereof.

It is, however, also possible to use epoxy resins in which the 1,2-epoxy groups are bonded to different heteroatoms or functional groups. Those compounds include, for example, the N,N,O-triglycidyl derivative of 4-aminophenol, the glycidyl ether glycidyl ester of salicylic acid, N-glycidyl-N′-(2-glycidyloxypropyl)-5,5-dimethylhydantoin, or 2-glycidyloxy-1,3-bis(5,5-dimethyl-1-glycidylhydantoin-3-yl)propane.

In addition, liquid prereacted adducts of such epoxy resins with hardeners are suitable for epoxy resins.

It is of course also possible to use mixtures of epoxy materials in the compositions according to the invention.

Preferred epoxy materials are cycloaliphatic diepoxides. Especially preferred are 3,4-epoxycyclohexylmethyl-3,4-epoxycyclohexanecarboxylate, bis(3,4-epoxycyclohexylmethyl)adipate, and combinations thereof. Other preferred epoxy materials are based on polynuclear phenols, such as, for example, bis(4-hydroxyphenyl)methane (bisphenol F), 2,2-bis(4-hydroxyphenyl)propane (bisphenol A), or oligomers thereof.

The epoxy materials can have molecular weights which vary over a wide range. In general, the epoxy equivalent weight, i.e., the number average molecular weight divided by the number of reactive epoxy groups, is preferably in the range of 44 to 1000.

The compositions of the present invention may also contain oxetanes as ring-opening type of polymerizable component. An oxetane compound comprises at least one oxetane ring

The oxetane compound can be polymerised or crosslinked by irradiation with light in the presence of a cationically polymerizable photoinitiator.

Specific examples of oxetane compounds are given below.

Compounds containing one oxetane ring in the molecule: 3-ethyl-3-hydroxymethyloxetane, 3-(meth)allyloxymethyl-3-ethyloxetane, 4-methoxy-[1-(3-ethyl-3-oxetanylmethoxy)methyl]benzene, [1-(3-ethyl-3-oxetanylmethoxy)ethyl]phenyl ether, isobutoxymethyl(3-ethyl-3-oxetanylmethyl)ether, ethyldiethylene glycol(3-ethyl-3-oxetanylmethyl)ether, 2-hydroxyethyl(3-ethyl-3-oxetanylmethyl)ether, 2-hydroxypropyl(3-ethyl-3-oxetanylmethyl)ether, butoxyethyl(3-ethyl-3-oxetanylmethyl)ether.

Compounds containing two or more oxetane rings in the molecule: 3,7-bis(3-oxetanyl)-5-oxa-nonane, 3,3′-(1,3-(2-methylenyl)propanediylbis(oxymethylene))bis-(3-ethyloxetane), 1,4-bis[(3-ethyl-3-oxetanylmethoxy)methyl]benzene, 1,2-bis[(3-ethyl-3-oxetanylmethoxy)methyl]ethane, 1,3-bis[(3-ethyl-3-oxetanylmethoxy)methyl]propane, ethylene glycol bis(3-ethyl-3-oxetanylmethyl)ether, triethylene glycol bis(3-ethyl-3-oxetanylmethyl)ether, tetraethylene glycol bis(3-ethyl-3-oxetanylmethyl)ether, trimethylolpropane tris(3-ethyl-3-oxetanyl methyl)ether, 1,4-bis(3-ethyl-3-oxetanylmethoxy)butane, 1,6-bis(3-ethyl-3-oxetanylmethoxy)hexane, pentaerythritol tris(3-ethyl-3-oxetanylmethyl)ether, pentaerythritol tetrakis(3-ethyl-3-oxetanylmethyl)ether, polyethylene glycol bis(3-ethyl-3-oxetanylmethyl)ether, dipentaerythritol hexakis(3-ethyl-3-oxetanylmethyl)ether, dipentaerythritol pentakis(3-ethyl-3-oxetanylmethyl)ether, dipentaerythritol tetrakis(3-ethyl-3-oxetanylmethyl)ether, caprolactone-modified dipentaerythritol hexakis(3-ethyl-3-oxetanylmethyl)ether, caprolactone-modified dipentaerythritol pentakis(3-ethyl-3-oxetanylmethyl)ether, ditrimethylolpropane tetrakis(3-ethyl-3-oxetanylmethyl)ether, EO-modified bisphenol A bis(3-ethyl-3-oxetanylmethyl)ether, EO-modified hydrogenated bisphenol A bis(3-ethyl-3-oxetanylmethyl)ether, EO-modified bisphenol F (3-ethyl-3-oxetanylmethyl)ether. These compounds can be used either individually or in combination of two or more.

Preferred oxetanes are selected from the group consisting of 3-ethyl-3-hydroxymethyloxetane, 2-ethylhexyl(3-ethyl-3-oxetanyl methyl)ether, 1,4-bis[(3-ethyl-3-oxetanylmethoxy)methyl]benzene, 1,2-bis[(3-ethyl-3-oxetanylmethoxy)methyl]ethane, 1,3-bis[(3-ethyl-3-oxetanylmethoxy)methyl]propane, ethylene glycol bis(3-ethyl-3-oxetanylmethyl)ether and bis(3-ethyl-3-oxetanylmethyl)ether.

The oxetane compounds can be used either individually or in combinations of two or more.

Other cationically polymerizable components that may be used in the composition of the present invention include, for instance, cyclic lactone compounds, cyclic acetal compounds, cyclic thioether compounds, spiro orthoester compounds, and vinylether compounds.

It is of course possible to use mixtures of cationically polymerizable components in the compositions according to the invention.

In one embodiment of the invention the composition of the invention may contain cationically polymerizable components having a cationically curable group and at least one hydroxyl group. Preferably this component will have one cationically curable group and one or more hydroxyl groups. It is believed that such components will also contribute to making a three dimensional object having a network with intermediate cross-link density.

Preferably the composition of the present invention comprises, relative to the total weight of the composition, at least 30 wt %, more preferably at least 40 wt %, and most preferably at least 60 wt % of cationically curable components. Preferably the composition of the invention comprises, relative to the total weight of the composition, less than 90 wt %, and more preferably less than 80 wt % cationically curable components.

The composition of the invention preferably contains at least one hydroxy component, which is a polyol having at least 2 hydroxyl groups. The hydroxy component used in the present invention is a polyol which may contain primary and/or secondary hydroxyl groups. It is preferred that the hydroxyl component contains at least one primary hydroxyl group. Primary hydroxyl groups are OH-groups, which are covalently bonded to a carbon atom having 2 or 3 hydrogen atoms. Preferably the hydroxy component contains two primary hydroxyl groups. In another preferred embodiment of the present invention the hydroxy component is a compound having primary hydroxyl groups and/or secondary hydroxyl groups located at the terminus of an alkyl or alkoxy chain, wherein the alkyl or alkoxy chain may have from 1 to 100 C-atoms, preferably from 2 to 50 C atoms, more preferably from 5-40 C atoms. While not wishing to be bound by theory, we believe these primary and secondary hydroxyl groups preferably function as chain transfer agents in the cationic polymerization reaction. Mixtures of different hydroxyl compounds may also be used.

The hydroxyl component may be a diol of molecular weight less than 200 wherein preferably one, and more preferably both, hydroxyl groups are primary hydroxyl groups. Examples of suitable diols include: ethylene glycol, 1,2-propanediol, 1,3-propanediol, 1,3-butanediol, 1,4-butanediol, 1,5-pentanediol, 1,6-hexanediol, diethylene glycol, triethyleneglycol, tetraethylene glycol, dipropylene glycol and tripropylene glycol.

The hydroxy component preferably is a molecule that has a central structure to which have been added chain extensions of, for example, ethylene oxide or propylene oxide. Preferably the hydroxy component is an alkoxylated polyol or an alkoxylated aromatic diol. More preferably the hydroxy component is an ethoxylated polyol or ethoxylated aromatic diol.

Examples of suitable hydroxy components are oligomeric and polymeric hydroxyl-containing materials include polyoxyethylene and polyoxypropylene glycols and triols of molecular weights from about 200 to about 1500 g/mol; polytetramethylene glycols of varying molecular weight; poly(oxyethylene-oxybutylene) random or block copolymers; hydroxy-terminated polyesters and hydroxy-terminated polylactones; hydroxy-functionalized polyalkadienes, such as polybutadiene; aliphatic polycarbonate polyols, such as an aliphatic polycarbonate diol; hydroxy-terminated polyethers;

Other preferred hydroxyl components are polyether polyols obtained by modifying a polyhydric alcohol containing two, three or more hydroxyl groups, such as trimethylolpropane, glycerol, pentaerythritol, sorbitol, sucrose, or quadrol, with a cyclic ether compound, such as preferably ethylene oxide (EO), optionally mixed with propylene oxide (PO), butylene oxide, or tetrahydrofuran. Specific examples include EO-modified trimethylolpropane, EO-modified glycerol, EO-modified pentaerythritol, EO-modified sorbitol, EO-modified sucrose, and EO-modified quadrol. Of these, EO-modified trimethylolpropane and EO-modified glycerol are preferable.

The molecular weight of the hydroxyl component is preferably 100-1500, and more preferably 160-1000 g/mol. The proportion of the hydroxyl component used in the liquid photocurable resin composition of the present invention is usually 1-35 wt %, preferably 5-30 wt %, and particularly preferably 5-25 wt %.

The radical polymerisation can be initiated with initiator. Conventional initiators such as a compound which thermally generates active radical species (heat polymerization initiator) and a compound which generates active radical species upon exposure to radiation (light) (radiation polymerization initiator) can be given.

There are no specific limitations to the radiation polymerization (photopolymerization) initiator insofar as such an initiator is decomposed by irradiation and generates radicals to initiate polymerization. Examples of such an initiator include acetophenone, acetophenone benzyl ketal, 1-hydroxycyclohexyl phenyl ketone, 2,2-dimethoxy-1,2-diphenylethan-1-one, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, benzoin propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, thioxanthone, diethylthioxanthone, 2-isopropylthioxanthone, 2-chlorothioxanthone, 2-methyl-1-[4-(methylthio)phenyl]-2-morpholino-propan-1-one, 2-benzyl-2-dimethylamino-1-(4-morpholinophenyl)-butanone-1,4-(2-hydroxyethoxy)phenyl-(2-hydroxy-2-propyl)ketone, 2,4,6-trimethylbenzoyldiphenylphosphine oxide, bis-(2,6-dimethoxybenzoyl)-2,4,4-trimethylpentylphosphine oxide, and oligo(2-hydroxy-2-methyl-1-(4-(1-methylvinyl)phenyl)propanone).

In the compositions according to the invention, any suitable type of photoinitiator that, upon exposure to actinic radiation, forms cations that initiate the reactions of the cationically polymerizable compounds, such as epoxy material(s), can be used. There are a large number of known and technically proven cationic photoinitiators that are suitable. They include, for example, onium salts with anions of weak nucleophilicity. Examples are halonium salts, iodosyl salts or sulfonium salts, such as are described in published European patent application EP 153904 and WO 98/28663, sulfoxonium salts, such as described, for example, in published European patent applications EP 35969, 44274, 54509, and 164314, or diazonium salts, such as described, for example, in U.S. Pat. Nos. 3,708,296 and 5,002,856. All eight of these disclosures are hereby incorporated in their entirety by reference. Other cationic photoinitiators are metallocene salts, such as described, for example, in published European applications EP 94914 and 94915, which applications are both hereby incorporated in their entirety by reference.

A survey of other current onium salt initiators and/or metallocene salts can be found in “UV Curing, Science and Technology”, (Editor S. P. Pappas, Technology Marketing Corp., 642 Westover Road, Stamford, Conn., U.S.A.) or “Chemistry & Technology of UV & EB Formulation for Coatings, Inks & Paints”, Vol. 3 (edited by P. K. T. Oldring), and both books are hereby incorporated in their entirety by reference.

Preferred initiators include diaryl iodonium salts, triaryl sulfonium salts, or the like.

There are no specific limitations to the cationic radiation polymerization (photopolymerization) initiator insofar as such an initiator is decomposed by irradiation and generates bronsted acid to initiate ring open reaction. Arylsulfonium hexafluoroantimontae salts, Arylsulfonium hexafluorophosphate salts, Aryliodonium hexafluoroantimontae salts, Aryliodonium hexafluorophosphate salts. Other preferred cationic photoinitiators include iodonium photoinitiators, e.g. iodonium tetrakis(pentafluorophenyl)borate, because they tend to be less yellowing, especially when used in combination with photosensitizers such as, for instance, n-ethyl carbazole.

In order to increase the light efficiency, or to sensitize the cationic photoinitiator to specific wavelengths, such as for example specific laser wavelengths or a specific series of laser wavelengths, it is also possible, depending on the type of initiator, to use sensitizers. Examples are polycyclic aromatic hydrocarbons or aromatic keto compounds. Specific examples of preferred sensitizers are mentioned in published European patent application EP 153904. Other preferred sensitizers are benzoperylene, 1,8-diphenyl-1,3,5,7-octatetraene, and 1,6-diphenyl-1,3,5-hexatriene as described in U.S. Pat. No. 5,667,937, which is hereby incorporated in its entirety by reference. It will be recognized that an additional factor in the choice of sensitizer is the nature and primary wavelength of the source of actinic radiation.

The amount of the polymerization initiator optionally used in the present invention is preferably 0.01-20 parts by weight, and still more preferably 0.1-10 parts by weight for 100 parts by weight of the composition. If the amount is less than 0.01 part by weight, hardness of the cured product may be insufficient. If the amount exceeds 20 parts by weight, the inside (inner layer) of the cured product may remain uncured.

As preferable examples of the heat polymerization initiator, peroxides and azo compounds can be given. Specific examples include benzoyl peroxide, t-butyl peroxybenzoate, and azobisisobutyronitrile.

Specifically, the cured product can be obtained as a coated form by applying the composition onto an object, drying the coating by removing volatile components at a temperature preferably from 0 to 160° C., and curing the coating by heat and/or radiation. In the case of curing the composition by applying heat, the composition is preferably cured at 20 to 110° C. for 10 seconds to 24 hours. When using radiation, use of ultraviolet rays or electron beams is preferable. In this case, the dose of ultraviolet rays is preferably 0.01-10 J/cm², and still more preferably 0.1-2 J/cm². Electron beams are preferably irradiated under the conditions of 10-300 kV, an electron density of 0.02-0.30 mA/cm², and at a dose from 1-10 Mrad.

The invention furthermore relates to the high-flux membranes. Such membranes exhibit favorable properties in membrane applications requiring high water flux even if low pressure can be applied, such as for example in bioreactors.

In one embodiment of the invention, the present invention relates to a hydrophilic membrane comprising a membrane carrier and a coating, the hydrophilic membrane having a pore size of about 100 nm or less while showing a flux of 3000 L/(m² h bar), if measured at 0.5 bar pressure. Preferably, the flux is about 5000 L/(m² h bar) or more.

Preferably, such flux is achieved with a membrane with a pore size of about 100 nm or less, as with a lower pore size, biofouling is further precluded.

In another preferred embodiment of the invention, the membrane carrier comprises UHMWPE, the hydrophilic membrane having a pore size of about 200 nm or less exhibits a flux of 500 L/(m² h bar), if measured at 0.5 bar pressure, preferably about 1500 L/(m² h bar) or more, and even more preferably, the hydrophilic membrane having a pore size of about 200 nm or less while exhibits a flux of 3000 L/(m² h bar), if measured at 0.5 bar pressure.

Preferably, the membranes are relatively thin, like for example 20, 40, 60, 80 or 100 μm thin.

The hydrophilic membranes of the present invention can be used in a large number of applications where filtration of water or water based mixtures is required.

In a preferred embodiment of the invention, the hydrophilic membrane is used in molecular separations, like particle filtration, micro filtration, ultra filtration, nano filtration, reverse osmosis. In one embodiment of the invention, the hydrophilic membrane is used in a membrane bioreactor (MBR), in a process for water purification. The membrane of the invention is in particular suitable in such process, because of the relatively high flow at low pressure, and a low tendency for fouling.

In another embodiment of the invention, the hydrophilic membrane is used in electrochemical applications, including electro-dialysis, electro-deionization and fuel cells

In yet another embodiment of the invention, the hydrophilic membrane is used in controlled release applications including pharmaceutical and nutraceutical compononents.

In a further embodiment of the invention, the hydrophilic membrane is used in pertraction, pervaporation and contactor applications.

The invention will be elucidated with the following, non-limiting examples.

### EXAMPLES

### Example 1-4

Four hydrophobic Solupor® membranes were used having different pore size. The membranes consisted of UHMWPE stretched material and had a base weight of about 16-14 g/m² (see type number, 16P or 14 P). Characteristics are given in table 1:

TABLE 1

| | | | Water | | | |
|---|---|---|---|---|---|---|
| | | Air | flux | Pore | Pore | |
| | Thickness | permeability | L/(m²h | size* | size** | Porosity |
| Type | μm | (L/cm2.min) | bar) | μm | μm | % |
| 16P25A | 141 | 42.2 | 0 | 2.0 | 1.4 | 89 |
| 16P15A | 139 | 29.2 | 0 | 1.4 | 1.0 | 88 |
| 16P10A | 117 | 9.3 | 0 | 0.4 | 0.4 | 86 |
| 14P02E | 86 | 3.2 | 0 | 0.1 | 0.1 | 84 |

*pore size measured with a PMI apparatus (based on air permeability and Galwick wetting fluid) based on ASTM F316-03
**pore size measured indirectly with air flow techniques via the air permeability without wetting fluid. The air permeability was measured according the Gurley test method and/or with a PMI capillary flow porometer (expressed in L/cm2.min). The relation between the Gurley (50 cc) number and air permeability is described in ISO 5636-5 section 10.1.

### Test Methods:

### Water Permeability:

The water permeability was measured at room temperature (20° C.) at a pressure gradient across the membrane of 500 mbar. 250 ml water is passed through the membrane under this pressure. The time elapsed for each 50 ml in the permeate side is recorded. Thereafter, the water flux is calculated according to the equation 1

J=Q/AtP (eq 1)

in which J is the flux (L/m² h bar), Q is the amount of water (in Liter) flowing through the membrane in the time period (h), A is the effective area of the membrane (m²), and P is the pressure difference through the membrane. The five measurements are averaged, and the average value is reported.

### Air Permeability:

The Gurley test method (according to ISO 5636-5) covers the determination of the resistance of membranes to the passage of air. The method is applicable to membranes that permit the passage of air up to 50 ml in one second or more. In this test, a Gurley Densometer from Toyoseiki, type B was used, with a recording the time in 0.1 seconds; with a cylinder capacity of 50 milliliters, a cylinder weight of 567 gram and a measuring surface of 6.45 square centimeter (1 square inch). After calibration, a strip of a membrane is cut across the width of the roll. And a smooth, undamaged test specimen is placed over the clamping plate orifice and clamped. The measurement is started, and the time is counted in units of 0.1 seconds, which is required for 50 milliliters of air to pass through the test specimen. The (average) Gurley value is recorded in seconds/50 ml.

The air permeability can also be measured with a PMI capillary flow porometer, expressed in L/cm2.min. Which can be translated via an empirical relation (dividing by 21.5 in the range below 0.4 μm) into pore size in μm

### Water Uptake:

Films were dried at 50° C. under vacuum till a constant weight was reached (W_{d}). Thereafter, samples were immersed in distilled water at room temperature (20° C.). After 2 hr, the samples were taken out of the water and surface droplets were gently removed with a paper tissue. The weight of the wetted membrane was recorded immediately (W_{w}), and the wettability (ε %) is calculated by the relative water gain (W_{w}−W_{d}) divided by the value, calculated if all the void volume of the membrane was filled with water; times 100%.

### Preparation of Functionalized Inorganic-Organic Materials

The functionalized metaloxide oligomers were prepared by mixing 10 g of tetra-ethoxy silane in 12.5 ml of ethanol with 23 mmol of organic silanes. In the case of acrylated oligomers, (3-acryloxypropyl)-trimethoxy-silane was used; in case of epoxy functional oligomers, 2-(3,4-epoxycyclohexyl)ethyl-tri-ethoxysilane was used. To the mixture comprising acrylates, a polymerisation inhibitor was added (hydroquinone mono-methylether, 1.5 wt % relative to the acryl-silane compound). The reaction mixture was heated till 40° C., and 0.1 N HCl was added drop-wise (2 ml for the acrylate mixture, 1.7 ml for the epoxy mixture), and the mixture was allowed to react at 40° C. for 24 hr while stirring. The material is hereinafter denoted as colloid. The GPC analysis of the acrylate functional oligomer on a Styragel column as described above, was: Mw: 6200, Mn 2200, polydispersity: 2.8-2.9.

### Coating Compositions

Four coating compositions were prepared with components as given in table 2. The coating compositions were prepared in 200 ml methanol.

The functionalized colloids were used as prepared, and used in ml; the other components are given in g.
PEG di-acrylate is polyethyleneglycol-diacrylate (Mw 575)
PEG acrylate is polyethyleneglycol-acrylate (Mw 375)
Photoinitiator is 1-hydroxy-cyclohexyl-phenyl-ketone
UVR is epoxy-cyclohexylmethyl-3,4-epoxycyclohexane carboxylate
PEG is polyethyleneglycol (Mw 600)
PEG monomethylether (PEGm) is polyethyleneglycol monomethyl ether (Mw 1100)
UVI is mixed arylsulphonium hexafluoroantimonate salts (cationic photoinitiator)

TABLE 2
Acrylate

| | Acrylated | PEG-di- | PEG- | Photo- |
|---|---|---|---|---|
| | colloid | acrylate | acrylate | initiator |
| Coat A | — | 0.25 | 5 | 0.025 |
| Coat B | 2 ml | 0.25 | 5 | 0.025 |

Epoxy

| | | | | PEG- | |
|---|---|---|---|---|---|
| | | | | mono | |
| | Epoxydised | | | methyl | |
| | colloid | UVR | PEG | ether | UVI |
| Coat C | — | 5 | 5.32 | 4.87 | 0.2 |
| Coat D | 2 ml | 5 | 5.32 | 4.87 | 0.2 |

### Preparation of the Coated Membrane

The membranes were pre-wetted with methanol for 5 min, and thereafter soaked with the coating compositions for 5 min. The membrane was taken out of the coating composition and dried in air for 3 min. After evaporation of the methanol, the coating was cured with UV radiation (the membrane was laid on a belt, which was transported 3 times under a UV lamp with an intensity of 1 J/cm², at a speed of 10 m/min). The membranes with the cured coatings were washed with methanol overnight, to remove all unreacted species, and subsequently washed with water. Next, the membranes were soaked in water overnight and dried in a vacuum oven at 50° C. till they reached a constant weight. The membranes with an hydrophilic coating are denoted with an ‘E’ in front.

### Testing of Coated Membranes

Coated membranes were washed with methanol for 70 hr, washed with water and dried under vacuum at 50° C. Thereafter, the water flux was measured. Results are given in table 3

TABLE 3
(water flux in L/(m² h bar) after methanol wash)

| | | Membrane | Membrane | Membrane |
|---|---|---|---|---|
| Example | Formulation | E16P25A | E16P10A | E14P02E |
| 1 | Coat A | 12079 | 0 | Nd |
| 2 | Coat B | 20034 | 0 | 0 |
| 3 | Coat C | 9147 | 731 | 0 |
| 4 | Coat D | 23808 | 3608 | 0 |

These result show that coatings B and D, with functionalized metaloxide colloids show higher water flux than coating without these inorganic materials. Furthermore, the epoxy-based coatings show an effective flux with membranes with smaller initial pores. It should furthermore be noted that the membranes with small pore-size were able to show water flux at somewhat higher pressure than the 0.5 bar used in this test. The pressure required to obtain water flux was substantially less than the pressure necessary to get water flux with untreated membranes, showing effective hydrophilisation with the coatings.

In a next set of experiments, the flux was measured after 70 hr warm water wash (50° C.). results are given in table 4:

TABLE 4
(water flux in L/(m² h bar) after warm water wash)

| | | Membrane | Membrane | Membrane |
|---|---|---|---|---|
| Example | Formulation | E16P25A | E16P10A | E14P02E |
| 1 | Coat A | 29088 | 0 | 0 |
| 2 | Coat B | 34985 | 569 | Nd |
| 3 | Coat C | 58467 | 3608 | 361 |
| 4 | Coat D | 60018 | 3636 | 258 |

The warm water wash is somewhat less severe than the methanol wash. The results also show, that epoxy based coatings perform better than acrylate based coatings. The results furthermore show that the acrylate based coatings can be improved with the reacted colloids, allowing higher flux, and an effective flux at lower pore size.

### Examples 5-9

A number of coating compositions have been prepared with several ratios epoxy relative to hydroxyl, by virtue of which the cross link density has been varied. The amounts are given in table 5. The coatings were dissolved in 200 ml methanol.

TABLE 5

| | | | | | | Epoxy/ |
|---|---|---|---|---|---|---|
| Coating | Epoxydized | UVR | PEG | PEG-m | UVI | hydroxyl |
| formulation | colloid | (g) | (g) | (g) | (g) | ratio |
| Coat E | 2 ml | 5 | 1.5 | 1.5 | 0.2 | 6.29 |
| Coat F | 2 ml | 5 | 3.0 | 3.0 | 0.2 | 3.14 |
| Coat G | 2 ml | 5 | 4.5 | 4.5 | 0.2 | 2.10 |
| Coat H | 2 ml | 5 | 5.3 | 5.0 | 0.2 | 1.81 |
| Coat J | 2 ml | 5 | 6 | 6 | 0.2 | 1.57 |

The 16P10A membrane was used as the membrane carrier in the further experiments (pore size of 0.4 μm, no water uptake and no water flux for an uncoated, hydrophobic membrane).

The membranes were coated as described above, and the pore size, as calculated with air flow relative to the uncoated membrane was measured, as well as the water uptake and water permeability. Results are given in Table 6.

TABLE 6

| | | Coating load | Pore size | Water | Water flux |
|---|---|---|---|---|---|
| Example | Coating | (g/m²) | (μm) | uptake | (L/m² h bar) |
| 5 | E | 6.6 | 0.10 | 63% | 180 |
| 6 | F | 4.0 | 0.06 | 72% | 860 |
| 7 | G | 1.4 | 0.13 | 83% | 1440 |
| 8 | H | 0.8 | 0.17 | 65% | 380 |
| 9 | J | 1.0 | 0.18 | 57% | 380 |

These experiments show, that pore size, coating loading and cross-link density can be used to influence and optimize water flux, pore size and other properties, even when starting from one standard hydrophobic membrane.

### Examples 10-12

With coating G a membrane (Solupor® 16P15A) was directly coated on a Minilabor roll to roll coater with a roll speed of 1.5 m/min and with different gravure speeds (60, 100, 150 rpm respectively). The coating was dried, and cured with UV light in 1-2 sec. and the roles of membrane were treated as described in the example 1. The experiments were performed twice, as shown under Exp A and Exp B. The water flux was measured as described above. Results are given in table 7.

TABLE 7

| | | | WATER | | |
|---|---|---|---|---|---|
| | GRAVURE | PORE SIZE | FLUX | PORE SIZE | WATER FLUX |
| | SPEED | (μm) | (L/m²hrbar) | (μm) | (L/m²hrbar) |
| EXAMPLE | (rpm) | Exp A | Exp A | Exp B | Exp B |
| 10 | 60 | 0.02* | 7162 | 0.08 | 6366 |
| 11 | 100 | 0.06 | 6857 | N.D. | 8830 |
| 12 | 150 | 0.07 | 11114 | N.D. | 12049 |

*probably an outlier

These experiments show, that without pre-wetting with ethanol, and on a roll-to-roll coater, very good results are obtained, suitable for commercial exploitation. Experiments 10-12 show that the invention enables the production of membranes with low pore size and extremely high water fluxes. (higher than conventional PS, PES, PVDF, CA and cellulose membranes). With the membrane of Example 12, further stability tests were performed as shown in table 8:

TABLE 8

| | Time | Water Flux |
|---|---|---|
| Test | (hr) | (L/m²hrbar) |
| 2% phosphoric acid | 46 | 8032 |
| 1% sodium hypochlorite | 54 | 9479 |
| Boiling water | ¼ (15 min) | 6139 |

These results show, that the harsh tests conditions on the hydrophilic membranes of the present invention do not have a large negative effect on the water flux after treatment.

1-40. (canceled)

41. A hydrophilic membrane comprising a porous membrane carrier and a hydrophilic coating impregnated in the membrane, wherein the coating comprises a covalently bound inorganic-organic hybrid material and wherein the coating is prepared from a hydrophilic coating composition comprising an inorganic-organic hybrid material with reactive groups, the inorganic part being a metal oxide oligomer.

42. The membrane of claim 41, wherein the metal oxide comprises at least one of silicium oxide, titanium oxide, magnesium oxide, stannous oxide, aluminium oxide, zirconium oxide, zinc oxide and cerium oxide.

43. The membrane of claim 42, wherein the reactive groups comprise at least one of alcohol (C—O—H), amine, mercapto, isocyanate, acrylate, vinyl, epoxy, and carboxylic acid.

44. The membrane of claim 43, wherein the amount of inorganic-organic hybrid material is about 2 wt. % or more of a solid material of the coating.

45. The membrane of claim 44, wherein the hydrophilic coating is obtained from the coating composition by polymerisation reactions comprising ring-opening polymerisation.

46. A hydrophilic membrane comprising a membrane carrier and a hydrophilic coating, wherein the hydrophilic coating is obtained from a coating composition by polymerisation reactions comprising ring-opening polymerisation.

47. The membrane of claim 46, wherein the coating composition exhibits a shrinkage of 8 vol. % or less upon cure.

48. The membrane of claim 47, wherein the viscosity of the coating composition is about 0.1 Pa·s or lower.

49. The membrane of claim 48, wherein the membrane carrier comprises ultra-high molecular weight polyethylene (UHMWPE).

50. The membrane of claim 49, wherein the membrane has a pore size of about 0.01 micrometer (μm) or more and about 1.0 micrometer (μm) or less, and further wherein the membrane exhibits a water flux of a least 5000 L/(m².h.bar), if measured at 0.5 bar.

51. The membrane of claim 50, wherein the porosity of the membrane carrier is about 15% or higher.

52. The membrane of claim 51, having a membrane carrier comprising UHMWPE, wherein the hydrophilic membrane having a pore size of about 200 nanometer (nm) or less exhibits a flux of 500 L/(m².h.bar), if measured at 0.5 bar pressure.

53. A process to obtain a hydrophilic membrane comprising the steps of (a) coating a membrane carrier with a coating composition, (b) wherein the coating composition comprises hydrophilic components with reactive groups and (c) an organic solvent.

54. The process of claim 53, wherein the solvent is substantially evaporated before cure.

55. The process of claim 54, wherein the curing is effected with radiation.

56. The process of claim 55, wherein the solvent comprises a polar non-protic solvent.

57. The process of claim 56, wherein the amount of coating as measured after a washing and drying step on self-bearing membranes is about 0.3 g/m² or more.

58. The process of claim 57, wherein the amount of coating after a washing and drying step is about 3% of the membrane weight or more.

59. A method comprising utilizing the hydrophilic membrane of claim 46 for at least one of molecular separation, particle filtration, micro filtration, ultra filtration, nano filtration, reverse osmosis, electrochemical applications, electro-dialysis, electro-deionization, fuel cells, controlled release applications, pharmaceutical components, nutraceutical components, pertraction applications, pervaporation applications, and contactor applications.

60. A method of tuning a pore size for hydrophilic membranes comprising, using a membrane carrier with a certain pore size, and a coating with a cross-link density, wherein the cross-link density is varied to obtain different pore sizes, a higher cross-link density giving smaller pore size.
